(19) United States
(12) Patent Application Publication
(10) Pub. No.: US 2009/0049485 A1
(43) Pub. Date: Feb. 19, 2009

(54) Method For Context-Based Channel Switching in Bandwidth Limited Television Systems

(75) Inventors: Dakshi Agrawal, Monsey, NY (US); Mandis Beigi, White Plains, NY (US); Chatschik Bisdikian, Chappaqua, NY (US); Kang-Won Lee, Nanuet, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINE CORPORATION, Armonk, NY (US)

(21) Appl. No.: 11/837,602

(22) Filed: Aug. 13, 2007

(51) Int. Cl. H04N 7/173

(52) U.S. Cl. 725/87

(57) ABSTRACT

A method for switching channels on a video playback device, the device receiving content from a plurality of channels transmitted by a digital video distribution network, the method including establishing a context for selecting additional channels; receiving a selection for another channel; updating the context with the selection; and transmitting the selection to the device and providing the additional channels for fast channel switching.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to digital video distribution networks and particularly to switching channels.

2. Description of the Related Art

In modern digital video transmission networks, one of the biggest challenges is providing viewers with a high quality experience. Providing viewers the high quality experience generally requires effectively managing operations that are simple in analog systems, such as switching channels. In analog television, video and audio portions of television transmissions are inherently synchronized with each other. A video signal and an audio signal can be initiated simultaneously from any part of an analog television signal. In digital television, the video signal and the audio signal are transmitted by separate packet streams (also known also as “packetized elementary streams” or PES). The PES are synchronized on the receiving end (at a digital television or a digital set-top-box (STB) connected to the digital TV) during playback. To preserve bandwidth, the video signal is encoded in such a way that each video frame will typically require information from additional encoded frames to be properly decoded. Thus, a waiting time is required for the additional frames to be transmitted prior to decoding. Further, PES buffering at the receiving end may be required to smooth out jitter in the transmission time of the received streams. The waiting time and the PES buffering can cause a significant delay in switching channels, on the order of a few seconds.

To manage bandwidth usage, some recent digital video distribution networks use one of multicast and unicast transmission architectures. In traditional broadcast transmission architectures, all of the TV channels that are available in an area (either off-the-air or through cable or satellite TV content providers) are transmitted to each and every TV receiver in that area. In contrast, with digital video distribution architectures (such as multicast and unicast transmissions), TV channels are selectively transmitted to smaller subsets of receivers that include viewers interested in the specific channels. These digital video distribution architectures, also referred to as switched broadcast, have been designed primarily to carry video programming over relatively low bandwidth links. The low bandwidth links provide point-to-point or point-to-multipoint “last mile” links that connect end-user premises (e.g., residences) to higher capacity core (or “backbone”) distribution networks.

Other types of service providers may also use the digital video distribution networks. Telephony service providers, for example, may use switched broadcast technologies to carry video programming using digital subscriber loop (DSL) technologies. Using the DSL technologies, the video programming is transmitted over the same twisted pair wires the telephone service providers use to provide telephony and, more recently, Internet services to residential customers. Fiber-to-the-node (FFTN) and fiber-to-the-curb (FFTC) are examples of distribution technologies in which a high-bandwidth core network (using fiber cabling) extends to a (small or large) residential neighborhood or the curbside and then uses twisted pair to provide services to end-users. Note that telephony, Internet, and TV services can all be transmitted over a common/converged transport communications layer based to Internet Protocol (IP) technologies. Television services using IP are commonly referred to as IPTV.

While switched broadcast distribution architectures permit the use of relatively low bandwidth in last mile access networks used to carry broadband services, the switched broadcast distribution architectures further exacerbate the delays in switching channels in digital video distribution networks. Generally, only a small number of channels are carried to a receiver at a viewer's premises. The number of channels could be on the order of two or three channels, especially when considering high-definition TV (HDTV) programming. Therefore, in addition to the switching delays previously discussed, an additional delay may occur if a newly selected channel is not among the small number of channels already transmitted to the receiver. With the unicast transmission, the newly selected channel (or the digital streams that comprise the newly selected channel) will need to be retrieved from a location in the digital video distribution network such as the TV service provider location itself. With the multicast transmissions, the newly selected channel may need to be retrieved from the distribution network outside of the neighborhood depending on whether neighbors are already viewing the newly selected channel.

When a user changes to a new channel, if the multicast transmission is employed and if it happens that a “neighbor” also receives the new channel, then the new channel can be streamed from a common upstream node, which is generally nearby. On the other hand, if no neighbor was watching the new channel, the new channel will be retrieved from content-providing servers located upstream in the distribution network such as at a super headend of the digital video distribution network.

An implementation of channel switching in a digital TV network that uses the switched broadcast technologies can result in a slow process, which may offset the potential benefits in using digital TV networks including multiple camera-views, rich data services like advanced interactive TV programming guides, and so on. Given the high level of expectation that TV viewers have already gained viewing analog broadcasts for many years, the speed of channel switching is a key quality of experience element for digital video transmission networks. Microsoft's IPTV offering (available from Microsoft Corporation of Redmond, Wash.) attempts to address this issue through a fast channel switch technology that relies on back-end servers that aid channel switching. Microsoft's fast channel switch technology is a client-server based solution that requires a coordinated deployment of matched server (in a video home office or VHO) and client (in a digital STB) components to implement complementary portions of a proprietary scheme. In any case, since requests for changing a channel must traverse the entire core network to reach a VHO, the equivalent of a head-end in a cable system, talking advantage of this feature entails a switching time that is at least as long as the round-trip delay between the STB and the VHO. Another proposed technology uses an adjacent multicast group join-leave method. The method permits the transmission of multiple join requests to multicast groups of viewers that receive the desired new channel (the switched to channel), as well as the adjacent channels to the new channel. However, the use of adjacent channels is a restrictive concept. The use of adjacent channels makes the presumption of “old-style” channel surfing (i.e., changing channels in a consecutive numerical order) common in analog TV systems.

What are needed are a method and a computer program product to provide for fast switching of channels in a digital video distribution network.

### SUMMARY OF THE INVENTION

The shortcomings of the prior art are overcome and additional advantages are provided through the provision of a method for switching channels on a video playback device, the device receiving content from a plurality of channels transmitted by a digital video distribution network, the method including establishing a context for selecting additional channels; receiving a selection for another channel; updating the context with the selection; and transmitting the selection to the device and providing the additional channels for fast channel switching.

Also disclosed is a computer program product stored on machine-readable media, the media including instructions for switching channels on a video playback device, the device receiving content from a plurality of channels transmitted by a digital video distribution network, the product having instructions for establishing a context for selecting additional channels wherein the context includes an algorithm, the algorithm executed by at least one of the device, customer premise equipment, the network, a remote site accessed via the Internet, and a television service provider; receiving a selection for another channel wherein the selection is performed by activating one input device; updating the context with another selection wherein the context includes at least one of a time, a day, a person, a group of people, a viewing pattern, a type of content, a transmission bandwidth, a storage characteristic of a set-top box, and a subscription level; transmitting the selection to the device and providing the additional channels for fast channel switching; and adjusting at least one of a bandwidth of the additional channels using a number of the additional channels requested and adjusting a time interval for transmitting the additional channels using the number.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that provides for fast switching of TV channels transmitted by a digital video distribution network, the solution includes a method for switching channels on a video playback device, the device receiving content from a plurality of channels transmitted by a digital video distribution network, the method including establishing a context for selecting additional channels; receiving a selection for another channel; updating the context with the selection; and transmitting the selection and the additional channels for fast channel switching.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of access links used in a digital video distribution network;

FIG. 2 illustrates an exemplary embodiment of the digital video distribution network;

FIG. 3 presents an exemplary method for requesting a channel;

FIG. 4 presents an exemplary method for transmitting channels;

FIGS. 5A and 5B, collectively referred to as FIG. 5, illustrate an exemplary embodiment of the teachings using additional channels with reduced definition; and

FIG. 6 illustrates an exemplary embodiment of the teachings using time division multiplexing to increase the number of channels transmitted.

The detailed description explains the preferred embodiments of the invention, together with advantages and features, by way of example with reference to the drawings.

### DETAILED DESCRIPTION OF THE INVENTION

The teachings provide a method and computer product for fast channel switching in a digital video distribution network. The teachings provide for generating and using context-based observations to learn from past viewing patterns of a subscriber and to predict the “next” channel to be selected. Predicted “next” channels are transmitted by the digital video distribution network to a point in the network close to the subscriber to provide the fast channel switching.

In some embodiments, the method and computer product are client based and do not require a matching server component at a head-end (or high tier) of the television distribution network such as a VHO. The teachings can be used with at least one of multicast and unicast television transmissions and, furthermore, may include use of backend servers if a channel switch request reaches the backend server. A context-based learning module (representing a client component), may reside in at least one of a TV set, a set-top-box attached to the TV set, a remote control, a residential gateway (which may be located at the boundary between a home premises and a providers network(s)), and, in certain embodiments, within the distribution network away from the home premises. When the context-based learning module is located within the distribution network, advanced channel switching services may be provided as a service by third party providers, including a digital service video provider.

For convenience, some acronyms used herein are now introduced. A “video home office” is referred to as a VHO. A “set-top box” is referred to as a STB. A “television” is referred to as a TV. “Fiber-to-the-node” is referred to as FTTN. A “digital subscriber loop” is referred to as DSL. A “DSL access multiplexer” is referred to as DSLAM. “Customer-premises equipment” is referred to as CPE. “High definition television” is referred to as HDTV. “Internet Protocol” is referred to as IP.

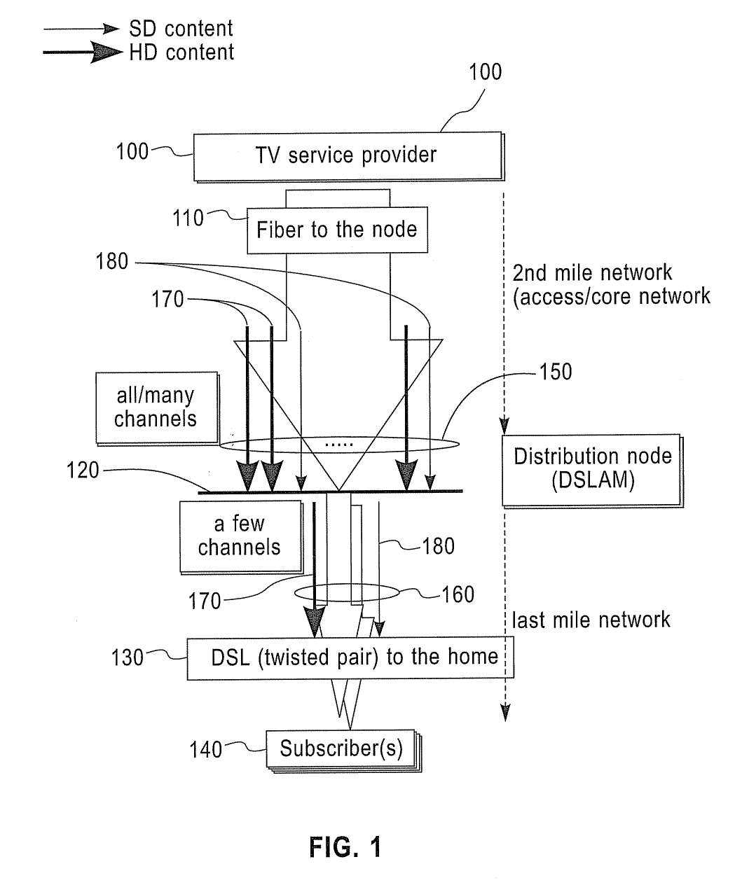

FIG. 1 illustrates an exemplary embodiment of access links used in a digital video distribution network for TV programming. The teachings are applicable to embodiments of the video distribution network in which portions of the network close to the home premises have constrained bandwidth. The constrained bandwidth provides for transmitting a small subset of an overall number of TV channels available for viewing. The overall number of TV channels is generally available in a higher-bandwidth core network. Referring to the embodiment of FIG. 1, the network of the digital video distribution network uses FTTN. The digital video distribution network includes high capacity “second-mile” access linls (i.e., fiber-to-the-node) that are able to transmit most or all of the TV channels and lower “last mile” links (DSL twisted pair) serving subscribers.

Again referring to FIG. 1, using FTTN, high capacity fiber cabling 110 transmits several (if not all) TV channels 150 from a TV service provider 100 to a distribution node 120 that serves a neighborhood of subscribers (or viewers) 140 that may be located up to a few thousand feet from the distribution node 120. The distance from the distribution node 120 to the subscriber 140 may be referred to as “the last mile link.” From the distribution node 120, pairs of twisted copper wires 130 of smaller bandwidth capacity than the fiber cabling 110 transmit a subset 160 of the TV channels 150 to each subscriber 140 separately. In addition to carrying TV programming, the pairs of twisted copper wires 130 may also carry voice and Internet services as well. As in “plain-old-telephone-services”, separate “strands” of copper cabling connect each subscribers' premises to the distribution (or access) node 120 that serves as an aggregator unit. The aggregator unit may be a DSL access multiplexer (DSLAM).

FIG. 1 also shows the fiber cabling 110 of the distribution network transmitting a number of standard TV programming channels 180 and high definition TV programming channels 170. Of the channels 180 and 170, only a small number of them may be carried over the pair of twisted copper wires 130. Thus, when viewers switch channels, the new channels they switch to may have to be serviced from the DSLAM 120 or even from a higher tier within the distribution network up and including the TV service provider 100. In general, channel switching with unicast transmissions require servicing from the higher tier within the distribution network.

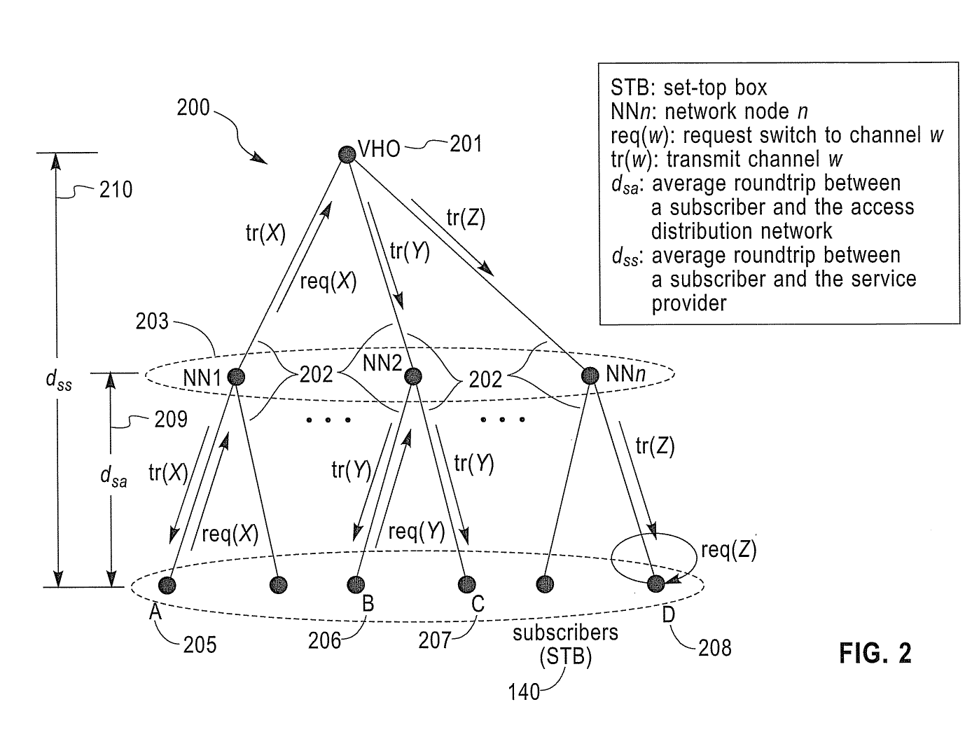

FIG. 2 illustrates an exemplary embodiment of a digital video distribution network 200 used for implementing the teachings herein. In particular, FIG. 2 illustrates channel transmission situations that may lead to faster times for channel switching. The teachings herein increase the frequency of occurrence of these channel transmission situations and, thus, decrease the overall time for channel switching. The digital video distribution network 200 connects a video head office (VHO) 201 with a plurality of subscribers 140. Generally, each subscriber 140 has an STB 204. The network includes a collection of multicast-enabled network nodes (NN) 203 connected through a collection of links 202. The collection of network nodes 203 and links 202 are referred to herein as network resources. In relation to FIG. 1, one class of such network nodes 203 are the DSLAM nodes 120; also, the links closer to the subscribers 140 have less capacity than those closer to the VHO 201. In FIG. 2, dₛₐ 209 represents the average roundtrip delay between the STBs 204 and the network nodes 202, while dₛₛ 210 represents the average roundtrip delay between STBs 204 and the VHO 201. Since, the VHO 201 and the STBs 204 are on the opposite sides of the network 200 that connects them, dₛₛ is usually greater than dₛₐ. As previously discussed, to conserve bandwidth multicast and unicast transmissions are used to transmit the TV channels only to those subsets of subscribers that are interested in viewing them. Several examples of channel switching are presented with respect to the digital video distribution network 200 presented in FIG. 2.

FIG. 2 shows exemplary subscribers A 205, B 206, C 207, and D 208 that are a subset of the subscribers 140. At some point the subscribers A 205, B 206, C 207, and D 208 may switch to a new channel (i.e., to a channel other than the one they currently view). Suppose that subscriber A 205 switches to channel X. In the example in FIG. 2, channel Xis not only unavailable to (i.e., not received by) the subscriber A 205 but is also unavailable to any other subscribers 140 that share network resources (i.e., have common network nodes 203 and/or links 202) with subscriber A 205. Since channel X is not available at the premises of the subscriber A 205, a request for channel X (req(X)) is sent from STB A 205 towards the VHO 201 of the service provider 100. Because, no other viewer of channel X shares network resources with the subscriber A 205, the request for channel X cannot be satisfied by any network node 203 serving the subscriber A 205 (i.e., by any node on the path between subscriber A 205 and the VHO 201). As a result, the request for channel X(req(X)) will propagate all the way to the VHO 201. The VHO 201 will provide a new transmission stream for channel X (tr(X)) and transmit channel X through the network nodes 203 to subscriber A 205. In this case, the average time it takes subscribers 140, in the same situations as subscriber A 205, to switch to a new channel is the round-trip propagation delay dₛₛ (plus the processing times in all the network nodes 203 and data servers in the VHO 201 involved in the switching process).

Referring to FIG. 2, suppose that subscriber B 206 switches to channel Y. Just as with subscriber A 205, channel Y is not available at the premises of subscriber B 206. However, contrary to the case with subscriber A 205 and channel X, there exists subscriber C 207 that too receives channel Y and also shares network resources with subscriber B 206. Let NN2 be the multicast-enabled network node closest (in network terms) to both subscribers B 206 and C 207. As before, a request for channel Y (req(Y)) is sent from the STB 204 of subscriber B 205 towards the VHO 201 of the service provider 100. However, as req(Y) reaches network node NN2, since channel Y is already transmitted to NN2 (on its way to subscriber C 207), the node NN2 will simply create a copy of the transmitted stream tr(Y) and multicast the new copy to subscriber B 206. In this case, the average time it takes subscribers 140, in the same situations as subscriber B 206, to switch to a new channel is the round-trip propagation delay dₛₐ (plus the processing times in all the network nodes 203 involved in the switching process). Given the extra propagation delay and associated data processing, it is evident that the switching time to channel X for subscriber A 205 will be longer than the switching time to channel Y for subscriber B 206, i.e., dₛₛ>dₛₐ.

Finally, referring to FIG. 2, suppose that subscriber D 208 switches to channel Z. Contrary to the previous cases, channel Z is available at the premises of subscriber D 208 (i.e., is among the channels 160 of FIG. 1 already transmitted to subscriber D 208). In this case, the switching time for subscriber D 208 to channel Z is minimal and less than the switching time experienced by subscribers A 205 and B 206 as the channel switching does not involve any of the network resources (202 and 203) or the VHO 201. The minimal switching time is demonstrated in FIG. 2 by showing that the request for channel Z (req(Z)) by subscriber D 208 loops right back to subscriber D 208.

Note that when channels are unicast to subscribers 140, or when the network nodes 203 are not multicast enabled, then requests for channel switching are serviced by the VHO 201 as in the case with subscriber A 205.

From the above discussion, it is noted that time for a channel switch is decreased the shorter the request for the channel switch propagates through the distribution network 200 provided by the service provider 100. In traditional TV systems, where all the channels (excluding on-demand channels) are transmitted to all the subscribers at all times, the request for switching a channel does not propagate beyond the set-top box in the subscriber's premises. For the digital video distribution network 200, the average switching time will decrease with a decrease in the frequency of occurrence of situations similar to the one encountered by subscriber A 205 or an increase of the frequency of occurrence of situations similar to the one encountered by subscriber D 208.

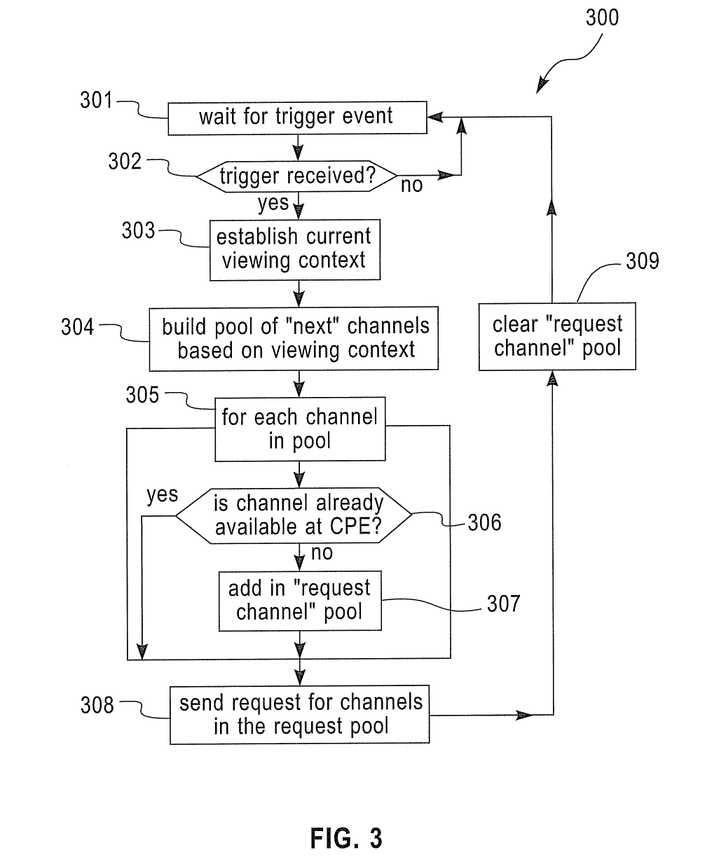

Since only a small number of channels can be carried at once to the premises of subscribers 140, there is a benefit in carefully selecting which channels are transmitted to subscribers 140 in order to affect the aforementioned frequencies in a favorable manner. According to the teachings herein, selection is achieved by sending requests for multiple channels that are associated with each other based on a viewing context of a requestor of switching channels. FIG. 3 shows an exemplary embodiment of a method 300 for selecting channels according to teachings herein

The method 300 creates a pool of the most likely channels to be viewed in the future by the subscriber 140 and hence proactively request the most likely channels from the service provider 100. Specifically, the method shown in FIG. 3 repeats itself every time a channel selection is requested. The method 300 is generally used when a switch to a new channel is requested. However, use of the method 300 is not intended to be limiting. The method 300 may not be used in every request for a channel selection. In general, the method 300 will wait 301 until a trigger event is received 302. Examples of trigger events include (but are not limited to) the request for switching a channel, such as when one subscriber 140 uses a TV set-top box remote control to switch a channel, a periodic timer timeout, or when a programmable timer is programmed to trigger a switch to a particular TV channel on a specific date and time. Upon receiving the triggering event, a current viewing context is established 303. Examples of parameters that in isolation or combination can influence the viewing context include (but are not limited to) the currently viewed channel, the channel to be switched to, previously viewed channels, i.e., the channel history including the amount of time of continuously viewing each channel, the time of day, the date of week, or time and date information in general, the person requesting the channel selection, the person group (e.g., family, children, parents), the content type (e.g., sports, kids programs, news), and so on. Based on the viewing context, a pool of potential “next” channels is created 304. The pool of next channels includes channels that have a high probability of being requested next. In cases when the method 300 has been triggered by a request for a channel selection, then one of the “next” channels may be the requested channel selection

The pool of potential next channels can be influenced by the current viewing context in a straightforward manner such as based on channel popularity, channel content, such as news, but also in a more elaborate manner. For example, if the currently viewed program is a sports event, e.g., football, and it is Sunday afternoon and a request for a channel selection is made by one subscriber 140 and an associated profile identifies the subscriber 140 as a sports fan, then it is highly probable that the channel selection is for another sports event. Therefore, some channels included in the pool of potential next channels can also be sports events. Channels may be selected for the pool in an even more refined manner to include only football games, or college football games, or football games covering local teams, or football games that are competitive in the final minutes of coverage, and so on. To select a more refined pool of potential next channels, a set of channel metadata available through electronic program guides (EPGs) provided by the TV service provider 100 can be used. In addition, when the set-top box 204 is networked, e.g., Internet-capable, an on-line information provider may provide the metadata.

From the above discussion, it is seen that the viewing context is derived from a variety of situations some of which are system independent (such as time and day), some of which are viewer dependent (such as a person profile), some of which are content dependent in broad terms (such as sports events), or narrow terms (such as local football games within five minutes to finish with less than a seven point differential), and so on. Thus, the viewing context can be used to create an elaborate pool of potential next channels that can be dynamically adjusted to reflect different conditions.

Referring to FIG. 3, each channel in the pool of potential next channels is checked to determine if the channel is already available at customer premises equipment (CPE) 306. In the exemplary embodiment of FIG. 3, the CPE is a TV set-top box, but in alternative embodiments the CPE can be a residential gateway or other appropriate device capable of receiving the TV channels from the TV service provider 100. Those channels that are not already available are added in a request channel pool 307. Further, the CPE transmits to the TV service provider 100 a request for the channels in the request pool 308. Following the transmission to the channel request, the request channel pool is cleared 309 in preparation for the next iteration of the method. Note that in this exemplary embodiment, the pool of potential next channels only includes the additional channels requested and not the channel already available. This embodiment is advantageous for reducing the bandwidth of upstream transmissions. In another embodiment, all the channels, both available and new additional ones, may be requested. This embodiment is advantageous for not requiring the transmission of a request to “drop” a channel that is already being transmitted to the premises of the subscriber 140.

The use of the method 300 usually requires the use of computing resources such as a computer processor, storage and memory. In one exemplary embodiment of the teachings herein, the computing resources may reside within the premises of the subscriber 140. Examples of the computing resources include the TV STB 204, the residential gateway, the remote control unit, or a combination of CPE devices. The method 300 uses these computing resources as the CPE. In another exemplary embodiment of the teachings herein, the computing resources may reside remotely to the premises of the subscriber 140 such as within a data server at the VHO 201 (shown in FIG. 2), or within the network node 203 (also shown in FIG. 2). The memory resources include at least one of persistent storage devices and temporary storage devices that are used to maintain internal state information used by the computer processor while performing the method 300. The storage devices are also used to create and manipulate the data structures that are used to form the pool of next channels (304 in FIG. 3) and the request channel pool (307 in FIG. 3).

In building the pool of next channels 304 in FIG. 3, context-sensitive algorithms (executed on the computer processor) can use various context sources and behavioral patterns to determine which additional channels to request. Various algorithms can be employed including (but not limited to) machine learning techniques, such as artificial neural networks, Bayesian analysis, and so on. For development of the behavioral patterns, there is a need for storing historical data, e.g., which channels were viewed at which times, days, for how long, by whom, and so on. Developing the behavioral patterns usually requires persistent storage devices for storing and maintaining the historical data even when power to the computing resources is turned-off.

By analyzing the historical data, context-sensitive learning algorithms may determine automatically the most probable additional channels that may be requested by the subscriber 140. In addition, interactive procedures can be employed for confirming the validity of an observed behavioral pattern. For example when the algorithm, based on historical data analysis, determines that a particular channel switching pattern occurs, the algorithm may ask if the subscriber 140 wants the algorithm to learn the switching pattern. Further, the algorithm may ask under which profile to store the switching pattern (family, person, etc.). The subscriber 140 may even enter through the remote control favorite shows that the subscriber 140 may want to watch. Such an action allows the CPEs to proactively request the desired channels from the TV service provider 100 so that the desired channels can be available for viewing by the time the desired program starts. In alternative embodiments, the subscriber 140 does not have to explicitly request changing of channels. In an exemplary embodiment of the interactive aspects discussed herein, a special window may be superimposed on the TV set displaying a menu of actions for selection that the subscriber 140 can navigate through using the remote control. The window may also provide editing capabilities for the subscriber 140 to enter information about personal preferences.

The exemplary method 300 depicted in FIG. 3 shows the steps taken to create the pool of channels to be requested from the service provider 100. In an exemplary embodiment of the teachings herein, any of the network nodes 203 (shown in FIG. 2) that satisfies the requests for the channels that are sent in step 308 in FIG. 3 can be at least one of the distribution node (DSLAM) 120 in FIG. 1 or channel serving data servers located in the VHO 201. The channel serving data servers are the sources of all TV channels transmitted to subscribers 140. In other embodiments, additional nodes, such as any of the network nodes 203 in FIG. 2, may be involved in serving the requests for channels. Next is described how the network nodes 203 process the requests for channels.

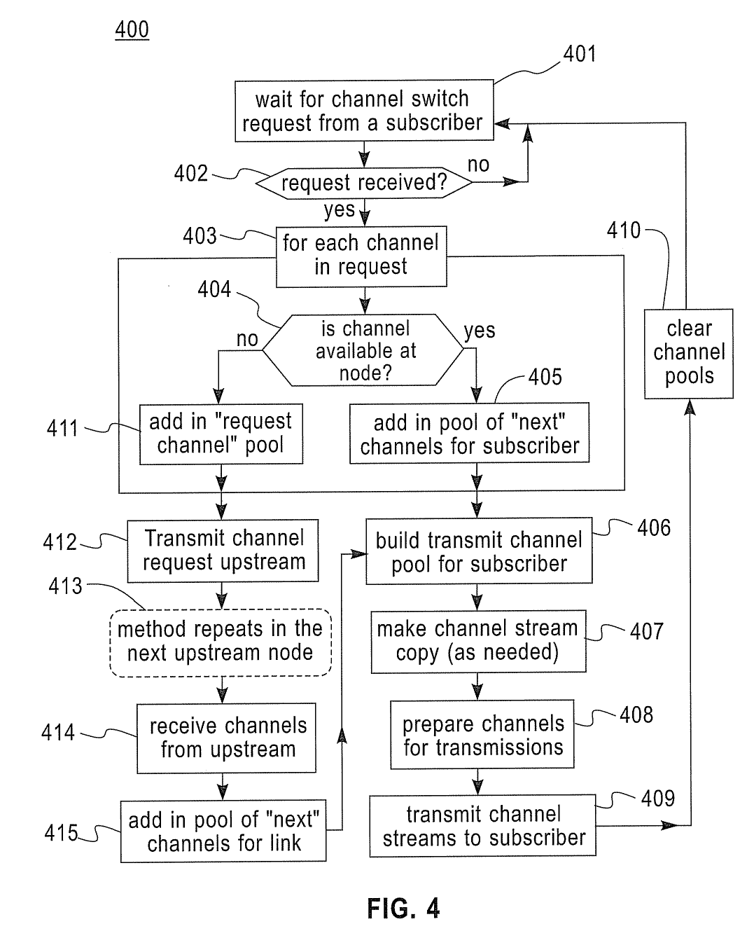

FIG. 4 presents an exemplary method 400 used by any of the nodes 203 for processing a request for channels. Note that in cases of nodes 203 that are multicast enabled, some of the functions represented by the steps in FIG. 4, such as “wait for channel switch request from a link” 401 and “transmit channel requests upstream” 412, can take advantage of the capabilities of the multicast-enabled nodes 203 and underlying multicast control protocols.

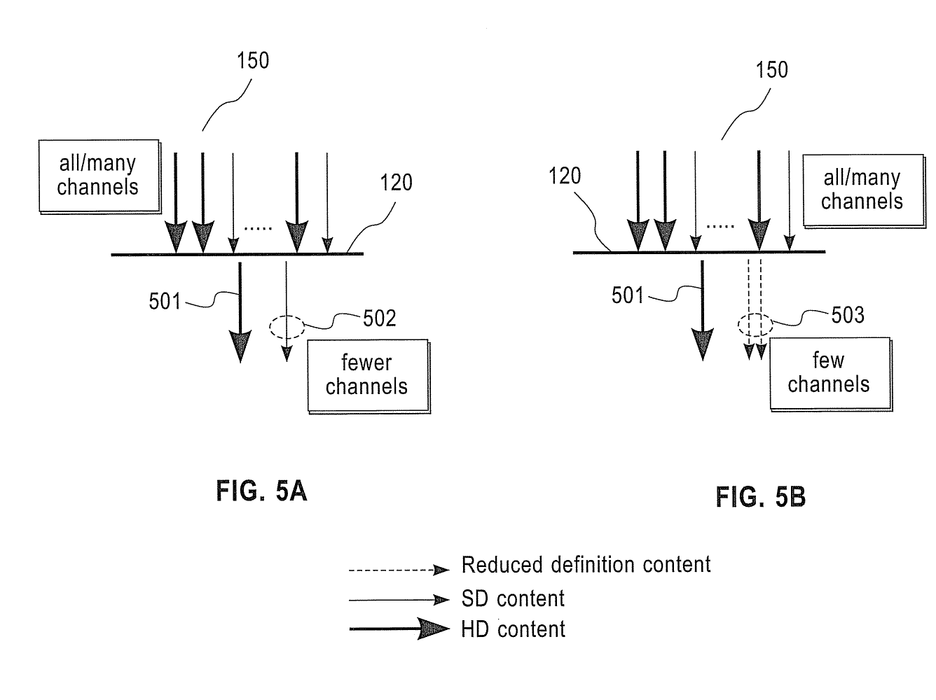

When the node 203 involved in the execution of the method 400 is a DSLAM distribution node 203, each subscriber 140 is served by a separate link 202 from the DSLAM node 203. Hence, subscribers 140 can be identified by the links 202 out of the DSLAM node 203 that serve them. According to the method 400 in FIG. 4, the node 203 waits 401 until it receives a channel request. The channel request includes receiving a request from at least one of the subscriber 140 (see 308 in FIG. 3) or a downstream node 203 (as in 413 in FIG. 4, to be discussed below). Upon receipt of a request 402 from the downstream node 203 on the link 202, the node 203 loops though all the channels in the request 403 and for each channel it performs the following. First, the node 203 determines whether the requested channel is available at the node 203 (404). The requested channel is available if a stream of the requested channel is transmitted to this node 203 from upstream. The node 203 can satisfy the request with the stream. If the requested channel is available (404 yes), the requested channel is added to the pool of next channels to be transmitted downstream on the link 202 towards to the subscriber 140 (405). When all the channels in the request have been processed (loop 403), the channels in the next channels pool is used to build the pool of channels that should be transmitted over the link 202 to the subscriber 140 (406). In the case of a DSLAM node 203, since the link 202 downstream between the node 203 and the subscriber 140 has smaller bandwidth than the link 202 upstream of the DSLAM node 203, the number of channels that can be sent to the subscriber 140 is limited. In step 406, if a number of channels in the transmit channel pool is too large, then the number is reduced. If a channel stream to be transmitted to a subscriber 140 is already transmitted to another subscriber 140 (over a different link 202), then a copy of the channel stream is made 408. When all the channels (and corresponding channel streams) to be transmitted to a subscriber 140 have been identified and are available at the node 203, the node 203 prepares the channels for transmission 407. Step 407 includes, among other things, scheduling transmission time, encoding and/or compressing as needed. Scheduling and compression alternatives are discussed further within the context of FIGS. 4 and 5. Further, the channel streams are transmitted to the subscriber 140 (409). Note that in an alternative embodiment, steps 405 and 406 may occur in tandem as each channel is processed in the loop 403. For example, the next channels and transmit channel pools may represent the same pool. The selection of which channel is added to the transmit channel pool may be decided by the maximum capacity of the pool, e.g., the first three channels are added and any subsequent channel is either not added or replaces a channel already in the pool. Of course, the actually requested channel shall remain present in the pool.

If a requested channel does not exist at the node 203 (404 no), then the node 203 will add the requested channel in a request channel pool 411 and transmit 412 the channel request upstream to be serviced by the next available node 203 in the network 200 where this method 400 is repeated again 413. When the requested channels are received from an upstream node 414, the requested channels are added in a next channel pool 415 and the method 400 continues from step 406 as before. In an alternative embodiment, steps 411 and 412 may be performed in tandem for each requested channel, i.e., for each requested channel that is not available at the node 203, a separate channel request is sent upstream.

The combination of the exemplary methods depicted in FIG. 3 and FIG. 4 allow the subscriber 140 to request more channels (excess channels) from an upstream node 203 than can be transmitted over the limited bandwidth link 202 to the subscriber 140. The excess channels are transmitted to the network node 203 that is close to the subscriber 140. Even though the excess channels cannot currently be transmitted to the subscriber, the excess channels become available to that node 203, and can still be used at that node 203 to reduce switching time. This resembles the case of subscriber B 206 in FIG. 2 in which a future channel switch request is satisfied by network node NN2. Therefore, even if a channel in the next channels pools cannot be transmitted to the subscriber when originally requested, the switching time when switching to this channel in the future can still be reduced because the channel can be accessed from the network node 203 close to the subscriber 140.

Different embodiments may be used in preparing the channels for transmission 407 in FIG. 4 or to request channels in the request pool 308 in FIG. 3. Specifically, the number of additional channels that can be transmitted depends on the total bandwidth available on any link 202 as well as the bandwidth required to carry each channel. Thus, alongside determining the collection of channels to request or transmit, an additional aspect of the teachings herein calls for increasing the number of the channels that can be transmitted (and correspondingly requested) on the lower bandwidth portion of the network (see 130 in FIG. 1).

FIG. 5 illustrates an exemplary embodiment for increasing the number of channels transmitted to the subscriber 140 by reducing resolution of some channels. FIG. 5 presents two cases of transmitting channels to the subscriber 140. In both cases, the subscriber 140 is interested in an HDTV channel depicted with arrow 501. Referring to FIG. 5A, along with the HDTV channel, one additional (standard definition) channel 502 is transmitted. Referring to FIG. 5B, additional channels 503 are encoded at a resolution level, which is lower than that of normal resolution. Due to the lower resolution, two additional channels 503 are now transmitted using the same bandwidth used by just the channel 502 in FIG. 5A. In FIG. 5B, if the subscriber 140 switches into one of the lower resolution channels 503, the lower resolution channel 503 selected can start showing immediately until a request for the normal resolution version of the lower resolution channel is satisfied. The request for the normal resolution version of the lower resolution channel is sent when the channel switching takes place. Thus, the added benefit in this embodiment is that the probability of switching to a channel that is already received increases, however, at the cost of viewing the channel at a lower resolution for a limited amount of time. In one embodiment, the amount of bandwidth reduction for the additional channels 503 can be a fixed system property, while in embodiment the amount of bandwidth may also depend on the number of additional channels 503 requested.

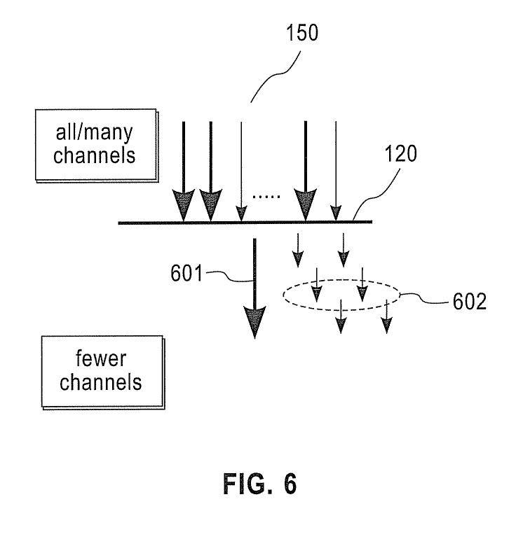

In yet another embodiment, the number of additional channels 503 is increased using short duration streams of the additional channels 503. The additional channels 503 are stored on the CPE (e.g., the STB 204 in FIG. 2) that have storage capability. The CPE with storage capability allows more additional channels 503 to be requested, but the additional channels 503 are stored in the CPE until the channel with a normal stream is received. FIG. 6 illustrates an exemplary embodiment for using the short duration streams. Employing time division multiplexing, the embodiment of FIG. 6 shows that over a period of time six channels 602 can be received using the bandwidth of two channels received using normal streams. The portion of one channel 602 stored in the STB is replaced during future transmissions of the same channel 602. If one channel 602 is not expected to be needed anymore, the one channel 602 may be replaced by a different channel 602. Additional embodiments may also combine the bandwidth reduction technique in the embodiment in FIG. 5 with the time division technique in the embodiment in FIG. 6.

Instead of the CPE requesting additional channels, the service provider 100 may schedule the staggered transmission of the additional channels 602. However, the scheduling technique requires that the service provider 100 maintains information about the viewing patterns of the subscriber 140, in which case the service provider 100 may use the context-sensing learning algorithms as well.

The embodiment of FIG. 6 gives rise to an operational model where channel switching becomes a service that can be provided by the TV service provider 100s or even third parties. In an embodiment of the operational model, a channel switching service provider may provide a Web-like site, which can be accessed by the subscriber 140 through one of a personal computer and other communications enabled device, e.g., an IP-enabled TV/STB. On that site, the subscribers 140 register programs of interest or more generally provide information about their viewing profiles. Based on that information, the channel switching service can start transmitting the programs proactively along paths toward potential viewers so these programs (or channels) are available closer to the subscriber 140. If a channel is not requested along certain paths within a period of time, transmission of the channel may terminate.

The capabilities of the present invention can be implemented in software, firmware, hardware or some combination thereof. For example, the CPE can include a processor, a communications bus, memory, storage, input devices, and output devices wherein the CPE can receive an input, the processor can execute instructions from at least one of the software and the firmware, and provide an output. The software and the firmware can include a computer program product stored on machine-readable media that can be executed by the CPE.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by at least one of the CPE and higher tier processing systems in the digital video distribution network 100 to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for switching channels on a video playback device, the device receiving content from a plurality of channels transmitted by a digital video distribution network, the method comprising:
establishing a context for selecting additional channels;
receiving a selection for another channel;
updating the context with the selection; and
transmitting the selection to the device and providing the additional channels for fast channel switching.

2. The method as in claim 1, wherein providing comprises transmitting at least one additional channel to a network node.

3. The method as in claim 1, wherein the context is implemented by an algorithm wherein the algorithm is executed by at least one of the device, customer premise equipment, the system, a remote site accessed via the Internet, and a video service provider.

4. The method as in claim 1, further comprising entering a selection by activating one input device.

5. The method as in claim 1, further comprising displaying the additional channels on a television wherein any of the additional channels can be input as the selection.

6. The method as in claim 1, wherein the context comprises at least one of a time, a day, a person, a group of people, a viewing pattern, a type of content, a transmission bandwidth, a storage characteristic of a set-top box, and a subscription level.

7. The method as in claim 1, further comprising at least one of adjusting a bandwidth of the additional channels using a number of the additional channels requested and adjusting a time interval for transmitting the additional channels using the number.

8. A computer program product stored on machine-readable media, the media comprising instructions for switching channels on a video playback device, the device receiving content from a plurality of channels transmitted by a digital video distribution network, the product comprising instructions for:
establishing a context for selecting additional channels wherein the context is implemented by an algorithm, the algorithm executed by at least one of the device, customer premise equipment, the system, a remote site accessed via the Internet, and a television service provider;
receiving a selection for another channel wherein the selection is performed by activating one input device;
updating the context with another selection wherein the context comprises at least one of a time, a day, a person, a group of people, a viewing pattern, a type of content, a transmission bandwidth, a storage characteristic of a set-top box, and a subscription level;
transmitting the selection to the device and providing the additional channels for fast channel switching; and
adjusting at least one of a bandwidth of the additional channels using a number of the additional channels requested and adjusting a time interval for transmitting the additional channels using the number.
